(19) United States
(12) Patent Application Publication
(10) Pub. No.: US 2012/0280639 A1
(43) Pub. Date: Nov. 8, 2012

(54) PLANAR LIGHTING MODULE

(75) Inventors: CHIH-YUNG LIN, Hukou (TW); WEN-LIANG TSENG, Hukou (TW); LUNG-HSIN CHEN, Hukou (TW); CHING-LIEN YEH, Hukou (TW); MIN-TSUN HSIEH, Hukou (TW); CHUAN-FU YANG, Hukou (TW)

(73) Assignee: ADVANCED OPTOELECTRONIC TECHNOLOGY, INC., Hsinchu Hsien 303 (TW)

(21) Appl. No.: 13/300,619

(22) Filed: Nov. 20, 2011

(30) Foreign Application Priority Data
May 2, 2011 (TW) 100115304

(51) Int. Cl. H05B 37/02

(52) U.S. Cl. 315/312

(57) ABSTRACT

A planar lighting module comprises a substrate, at least one light guide device and a driver. A frame is located on the substrate for fastening the at least one light guide device and the driver. By manipulation and binding, the planar lighting module can be easily assembled or dismantled, no screws or welded joints are used, and it is also convenient to service.

### TECHNICAL FIELD

The disclosure relates generally to lighting, and more particularly to a planar lighting module.

### DESCRIPTION OF THE RELATED ART

Presently, many planar lighting modules, such as T8-type lamps, may comprise a lamp box and a cover located on a light emitting face, wherein the lamp box is used to install lamp holders, drivers, tubes and other related components. However, these planar lighting modules have large volume and complex construction that may cause an increase in the prime cost and result in difficulties of manufacture thereof. Moreover, it is inconvenient to dismantle or to service the planar lighting module due to a number of screws or welded joints are used to assemble these components into one planar lighting module. Furthermore, when the planar lighting module is suspended above and the screws inside the planar lighting module slacken that may cause a danger.

### BRIEF DESCRIPTION OF THE DRAWINGS

FIG. 1 is an exploded view showing a planar lighting module of the disclosure.

FIG. 2 is a cross section of a light guide device of the planar lighting module of FIG. 1.

FIG. 3 is a cross section of a driver of the planar lighting module of FIG. 1.

### DETAILED DESCRIPTION

Exemplary embodiments of the disclosure will be described with reference to the accompanying drawings.

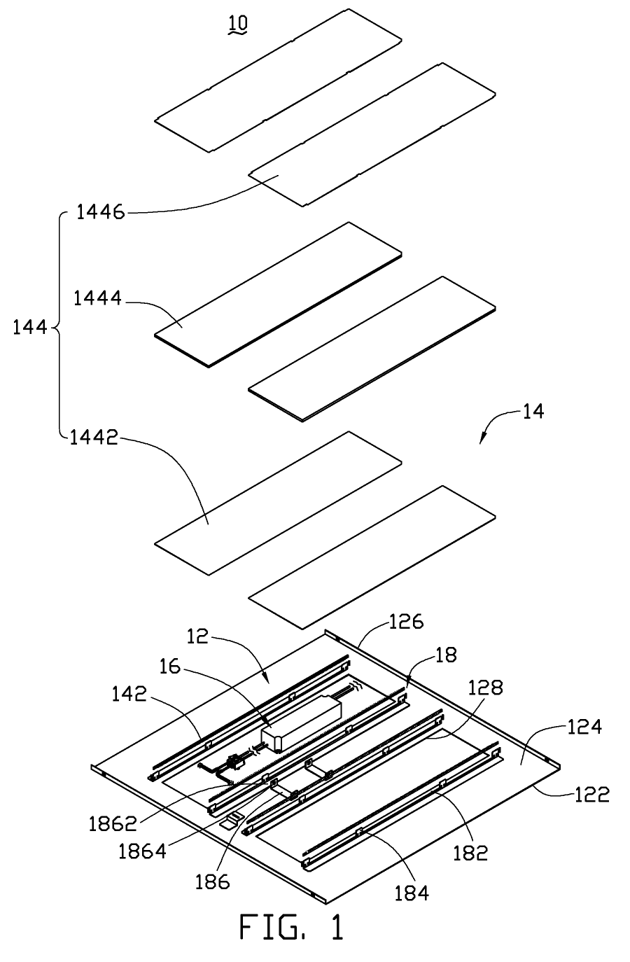

Referring to FIG. 1, the disclosure provides a planar lighting module 10 comprising a substrate 12, at least one light guide device 14 and a driver 16. The substrate 12 comprises a first face 122 and a second face 124 opposite to each other, wherein the first face 122 defines at least one light emitting face 128. The at least one light emitting face 128 penetrates through the substrate 12 from the first face 122 to the second face 124, wherein the back of the at least one light emitting face 128 is located on the second face 124. The substrate 12 can be made of metal, plastic, timber or polymers.

The at least one light guide device 14 and the driver 16 are allocated on the second face 124. In this embodiment, a rim 126 is located on the edge of the second face 124, to facilitate the fastening of the planar lighting module 10 on a ceiling for example, or a light steel frame (not shown). More specifically, the substrate 12 is a rectangular plane and the rim 126 is located on two parallel edges of the second face 124. These rim 126 is bent up from the substrate 12 and stands erects on the edge of the second face 124, whereby the planar lighting module 10 can be suspended on a certain place via the rim 126. Such that, the second face 124 is hung from a suspending piece and the at least one light emitting face 128 may be orientated to the outside or oriented in a particular direction when giving illumination.

The back of the at least one light emitting face 128 corresponds to the location of the second face 124 where the at least one light guide device 14 is allocated thereon. In this embodiment, there are two light emitting faces 128 corresponding to the two light guide devices 14. The at least one light guide device 14 comprises at least one light source 142 and a plurality of optical films 144. The at least one light source 142 may be composed of numerous spot light sources or an integrally-linear light source such as a light bar or a tube. In this embodiment, the at least one light source 142 is composed of numerous spot light sources such as light emitting diodes (LEDs). The plurality of optical films 144 comprises a diffuser 1442, a light guide plane 1444 and a reflector 1446 disposed in that order, wherein the diffuser 1442 is adjacent to the at least one light emitting face 128. In this embodiment, the at least one light guide device 14 is larger than the at least one light emitting face 128 so that the at least one light guide device 14 is always held in place on the at least one light emitting face 128. The at least one light source 142 is located adjacent to the plurality of optical films 144, therefore light emitted from the at least one light source 142 may be transformed into a planar light source via the plurality of optical films 144. Then, the planar light source is directed to the at least one light emitting face 128. In another embodiment, the at least one light guide device 14 comprises two light sources 142 adjacent to the two opposite edges of the at least one light guide device 14.

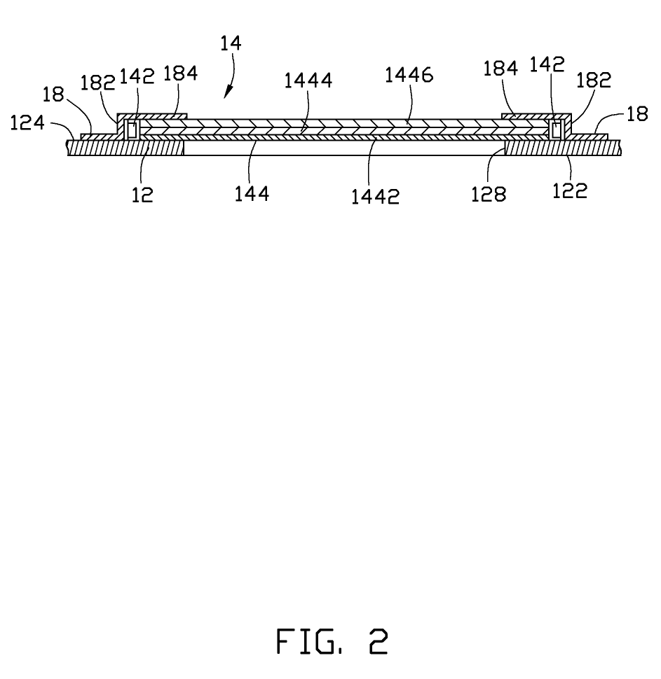

A frame 18 is located on the second face 124 around the at least one light guide device 14 for receiving the plurality of optical films 144. In particular, the frame 18 comprises a main body 182 on which the at least one light source 142 is located, and a tenon 184 corresponds to the at least one light guide device 14 for fastening the plurality of optical films 144 onto the substrate 12. In this embodiment, the main body 182 comprises two battens each having a plurality of tenons 184 corresponding to the plurality of optical films 144. As shown in FIG. 2, the surface of the main body 182 which faces the at least one light guide device 14, provides the light sources 142. The plurality of optical films 144 can be held inside the frame 18, wherein the plurality of optical films 144 is sandwiched between the second face 122 and the tenons 184. In this embodiment, the tenon 184 is made integrally by extending it from the main body 182, or it can be made separately. Additionally, the light sources 142 and the optical films 144 are at an unchanging distance from each other.

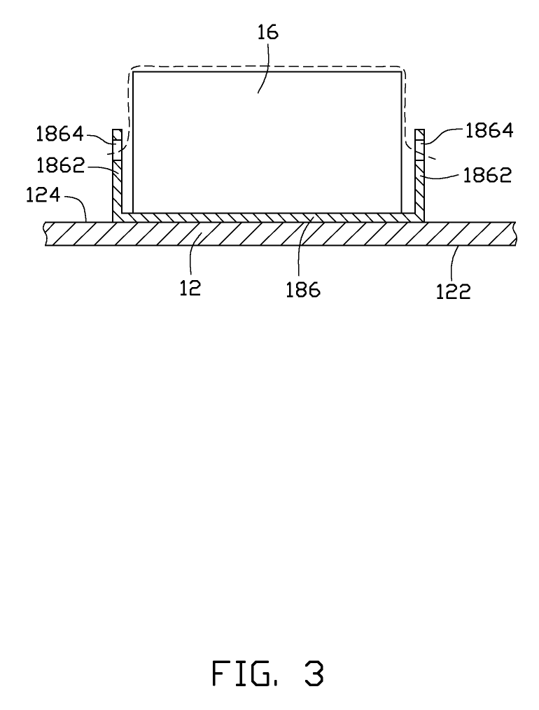

Referring to FIG. 3, the driver 16 is located on the second face 124. In this embodiment, the substrate 12 comprises a binding hook 186 located on the second face 124 around the driver 16, whereby the driver 16 can be fastened on the second face 124 by the binding hook 186. The binding hook 186 comprises a fixed device 1862 around the driver 16, and a number of openings 1864 located on the fixed device 1862. By these means, the driver 16 can be bound on the binding hook 186 by using a cord or strap (referring to the dotted line in FIG. 3) crossing the openings 1864. The driver 16 makes electrical contact with the light source 142 so that the light source 142 is capable of emitting light.

Accordingly, the disclosure provides a planar lighting module 10 containing a frame 18 for fastening the at least one light guide device 14 and the driver 16. By manipulation and binding, the planar lighting module 10 can be easily assembled or dismantled without screws or welding, and is also convenient to service. Moreover, the planar lighting module 10 has a very simple construction and fewer components which may lead to reduced prime costs.

It is to be understood, however, that even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A planar lighting module, comprising:
a substrate, having a first face and a second face opposite to each other, wherein the first face defines at least one light emitting face;
at least one light guide device, located on the second face and facing to the back of the at least one light emitting face;
a frame, located on the second face around the at least one light guide device;
at least one light source, located on the second face and facing to the at least one light guide device; and
a driver, located on the second face and electrically connecting to the least one light source.

2. The planar lighting module as claimed in claim 1, wherein a rim is located on an edge of the second face.

3. The planar lighting module as claimed in claim 2, wherein the rim is located on two parallel edges of the second face.

4. The planar lighting module as claimed in claim 1, wherein the at least one light source is composed of numerous spot light sources.

5. The planar lighting module as claimed in claim 1, wherein the at least one light guide device comprises a plurality of optical films.

6. The planar lighting module as claimed in claim 5, wherein the plurality of optical films each comprises a diffuser, a light guide plane and a reflector disposed sequentially, and the diffuser is adjacent to the at least one light emitting face.

7. The planar lighting module as claimed in claim 6, wherein the at least one light guide device is lager than the at least one light emitting face.

8. The planar lighting module as claimed in claim 1, wherein there are two light sources adjacent to two opposite edges of the at least one light guide device.

9. The planar lighting module as claimed in claim 1, wherein the frame comprises a main body and a tenon corresponding to the at least one light guide device.

10. The planar lighting module as claimed in claim 9, wherein the main body comprises two battens corresponding to the plurality of optical films.

11. The planar lighting module as claimed in claim 1, wherein a binding hook is located on the second face, and the driver is fastened on the substrate by the binding hook.

12. The planar lighting module as claimed in claim 11, wherein the binding hook comprises a fixed device and a number of openings located on the fixed device.

13. The planar lighting module as claimed in claim 12, wherein the driver is bounded on the binding hook by using a cord crossing the openings.

14. A planar lighting module, comprising:
a substrate, having a first face and a second face opposite to each other, wherein the first face defines at least one light emitting face;
at least one light guide device, located on the second face and facing to the back of the at least one light emitting face, having at least one light source located on the second face and facing to the at least one light guide device; and
a driver, located on the second face and electrically connecting to the least one light source.

15. The planar lighting module as claimed in claim 14, wherein a frame is located on the second face around the at least one light guide device.

16. The planar lighting module as claimed in claim 14, wherein a rim is located on an edge of the second face.

17. The planar lighting module as claimed in claim 14, wherein the at least one light guide device comprises a diffuser, a light guide plane and a reflector disposed sequentially, and the diffuser is adjacent to the at least one light emitting face.

18. The planar lighting module as claimed in claim 14, wherein a binding hook is located on the second face, and the driver is fixed on the substrate by the binding hook.

19. The planar lighting module as claimed in claim 18, wherein the binding hook comprises a fixed device and openings located on the fixed device, the driver is bounded on the binding hook by using a cord crossing the openings.

20. The planar lighting module as claimed in claim 14, wherein there are two light sources adjacent to two opposite edges of the at least one light guide device.
